(19) United States
(12) Patent Application Publication
(10) Pub. No.: US 2024/0375892 A1
(43) Pub. Date: Nov. 14, 2024

(54) MAGAZINE FOR LIGHT STICKS

(71) Applicant: Blue Force Gear, Inc., Pooler, GA (US)

(72) Inventors: Ashley A. Burnsed, JR., Savannah, GA (US); Stephen G. Hilliard, Charleston, SC (US)

(21) Appl. No.: 18/784,575

(22) Filed: Jul. 25, 2024

Related U.S. Application Data
(63) Continuation-in-part of application No. 16/740,536, filed on Jan. 13, 2020.
Application No. 16/740,536 is a continuation of application No. 16/157,532, filed on Oct. 11, 2018, now Pat. No. 10,577,197.
Application No. 16/157,532 is a continuation-in-part of application No. 15/405,542, filed on Jan. 13, 2017, now abandoned.
(60) Provisional application No. 62/571,306, filed on Oct. 12, 2017.

(51) Int. Cl. B65G 59/02

(52) U.S. Cl. CPC B65G 59/02

(57) ABSTRACT

An apparatus having a first body defining a chamber configured to contain a stack of elongated light sticks. The first body further defining an exit aperture communicating with the chamber and a proximate to a light stick feeding position. A second body pivotable about the first body. The second body including a movable actuator movable between a rest position and an actuated position. The apparatus having an anvil configured for a light stick within the light stick feeding position to bend around, a pair of engagement arms. The pair of engagement arms are operable to flex the light stick occupying the light stick feeding position against the anvil of the first body to fracture an internal element. The apparatus having a hinge arrangement configured to allow the pivoting of the second body around the first body. The light stick ejected in a single actuation of the movable actuator.

### CROSS-REFERENCE TO RELATED APPLICATIONS

This application is Continuation-in-Part of U.S. patent application Ser. No. 16/740,536 filed on Jan. 13. 2020, entitled “MAGAZINE FOR LIGHT STICKS,” which is a Continuation of U.S. patent application Ser. No. 16/157,532 filed on Oct. 11, 2018, now issued as U.S. Pat. No. 10,577,197 entitled “MAGAZINE FOR LIGHT STICKS,” which is a Continuation-in-Part of U.S. patent application Ser. No. 15/405,542 filed on Jan. 13, 2017, entitled “MAGAZINE FOR LIGHT STICKS,” and also claims the benefit of U.S. Provisional Patent Application No. 62/571,306 filed on Oct. 12, 2017, entitled “CQB Marker-MARCO,” which are hereby incorporated by reference in their entirety for all that is taught and disclosed therein.

### FIELD OF THE INVENTION

The present invention relates to magazines, and more particularly to a magazine for light sticks.

### BACKGROUND OF THE INVENTION

A magazine is most commonly viewed as an ammunition storage and feeding device attached to a repeating firearm. The magazine functions by moving the cartridges stored in the magazine into a position where they may be chambered by the action of the firearm. Most magazines designed for use with a reciprocating bolt firearm utilize a set of feed lips which stops the vertical motion of the cartridges out of the magazine, but allows one cartridge at a time to be pushed forward (stripped) out of the feed lips by the firearm's bolt into the chamber.

Some form of spring and follower combination is almost always used to feed cartridges to the lips, which are typically located in the magazine. A box magazine, the most popular type of magazine in modern rifles and handguns, stores cartridges in a straight or gently curved column, either one above the other or staggered zigzag fashion. As the firearm cycles, cartridges are moved to the top of the magazine by a follower driven by spring compression to either a single feed position or alternating feed positions. A detachable box magazine is a self-contained mechanism capable of being loaded or unloaded while detached from the host firearm.

Military and law enforcement personnel currently rely on four-inch chemical light sticks to mark doorways and other entrances when engaged in close quarter combat and room clearings. Traditional marking techniques employed by modern warfighters pose many challenges. Conventional solutions for storing and dispensing four-inch chemical light sticks are bulky and difficult to employ and prepare, resulting in wasted man hours and frustration.

Therefore, a need exists for a new and improved magazine for light sticks that houses and enables one-handed dispensing and activating of chemical light sticks. In this regard, the various embodiments of the present invention substantially fulfill at least some of these needs. In this respect, the magazine for light sticks according to the present invention substantially departs from the conventional concepts and designs of the prior art, and in doing so provides an apparatus primarily developed for the purpose of providing a container that enables one-handed dispensing and activation of chemical light sticks.

### SUMMARY OF THE INVENTION

The present invention provides an improved magazine for light sticks, and overcomes the above-mentioned disadvantages and drawbacks of the prior art. As such, the general purpose of the present invention, which will be described subsequently in greater detail, is to provide an improved magazine for light sticks that has all the advantages of the prior art mentioned above.

To attain this, the preferred embodiment of the present invention essentially comprises an elongated tubular body defining a chamber configured to contain a stack of elongated light sticks, the body defining an exit aperture communicating with the chamber and proximate to a light stick feeding position, a movable actuator proximate the exit aperture and movable between a rest position and an actuated position, the body having a retention element proximate the exit aperture, the actuator having a contact portion spaced apart from the retention element, and the retention element and contact portion being operable to flex a light stick occupying the light stick feeding position in response to movement of the actuator from the rest position to the actuated position. The retention element and contact portion may be operable to eject the light stick occupying the light stick feeding position in response to movement of the actuator from the rest position to the actuated position. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is an exploded view of the current embodiment of the magazine for light sticks constructed in accordance with the principles of the present invention.

FIG. 2 is a front isometric view of the current embodiment of the magazine for light sticks of FIG. 1.

FIG. 3 is a front view of the current embodiment of the magazine for light sticks of FIG. 1.

FIG. 4 is a side sectional view of the current embodiment of the magazine for light sticks of FIG. 1.

FIG. 5 is a left side view of the current embodiment of the magazine for light sticks of FIG. 1 showing the process for dispensing and activating a light stick.

FIG. 6A is a front exploded view of a first alternative embodiment of the magazine for light sticks constructed in accordance with the principles of the present invention.

FIG. 6B is a rear exploded view of the alternative embodiment of the magazine for light sticks of FIG. 6A.

FIG. 7A is a front isometric view of the first alternative embodiment of the magazine for light sticks of FIG. 6A in the ready to dispense a light stick condition.

FIG. 7B is a front isometric view of the first alternative embodiment of the magazine for light sticks of FIG. 6A in the process of dispensing a light stick.

FIG. 7C is a front isometric view of the first alternative embodiment of the magazine for light sticks of FIG. 6A immediately after dispensing a light stick.

FIG. 7D is a front isometric view of the first alternative embodiment of the magazine for light sticks of FIG. 6A having returned to the ready to dispense a light stick condition after dispensing a light stick.

FIG. 8A is a side sectional view taken along lines 8A-8A of FIG. 7A.

FIG. 8B is a side sectional view taken along lines 8B-8B of FIG. 7B.

FIG. 8C is a side sectional view taken along lines 8C-8C of FIG. 7C.

FIG. 8D is a side sectional view taken along lines 8D-8D of FIG. 7D.

FIG. 9A is a side sectional view taken along lines 9A-9A of FIG. 7A.

FIG. 9B is a side sectional view taken along lines 9B-9B of FIG. 7B.

FIG. 9C is a side sectional view taken along lines 9C-9C of FIG. 7C.

FIG. 9D is a side sectional view taken along lines 9D-9D of FIG. 7D.

FIG. 10 is a bottom view of the first alternative embodiment of the magazine for light sticks of FIG. 6A in the process of dispensing a light stick.

FIG. 11 is a front isometric view of the first alternative embodiment of the magazine for light sticks of FIG. 6A shown in use by a user to dispense a light stick.

FIG. 12 is a front isometric view of a second alternative embodiment of the magazine for light sticks constructed in accordance with the principles of the present invention.

FIG. 13A is a side sectional view of the second alternative embodiment of the magazine for light sticks of FIG. 12 in the ready to dispense a light stick condition.

FIG. 13B is a side sectional view of the second alternative embodiment of the magazine for light sticks of FIG. 12 in the process of dispensing a light stick with the light stick partially flexed.

FIG. 13C is a side sectional view of the second alternative embodiment of the magazine for light sticks of FIG. 12 in the process of dispensing a light stick with the light stick fully flexed.

FIG. 14 is a front exploded perspective view of a third alternative embodiment the magazine for light sticks in accordance with the principles of the present inventor.

FIG. 15 is a rear exploded perspective view of the third alternative embodiment the magazine for light sticks in accordance with the principles of the present inventor.

FIG. 16 is a front perspective view of the third alternative embodiment the magazine for light sticks in a closed configuration in accordance with the principles of the present inventor.

FIG. 17 is a rear perspective view of the third alternative embodiment the magazine for light sticks in a closed configuration in accordance with the principles of the present inventor.

FIG. 18 is a rear view of the third alternative embodiment the magazine for light sticks in an open configuration in accordance with the principles of the present inventor.

The same reference numerals refer to the same parts throughout the various figures when possible.

### DESCRIPTION OF THE CURRENT EMBODIMENT

An embodiment of the magazine for light sticks of the present invention is shown and generally designated by the reference numeral 10.

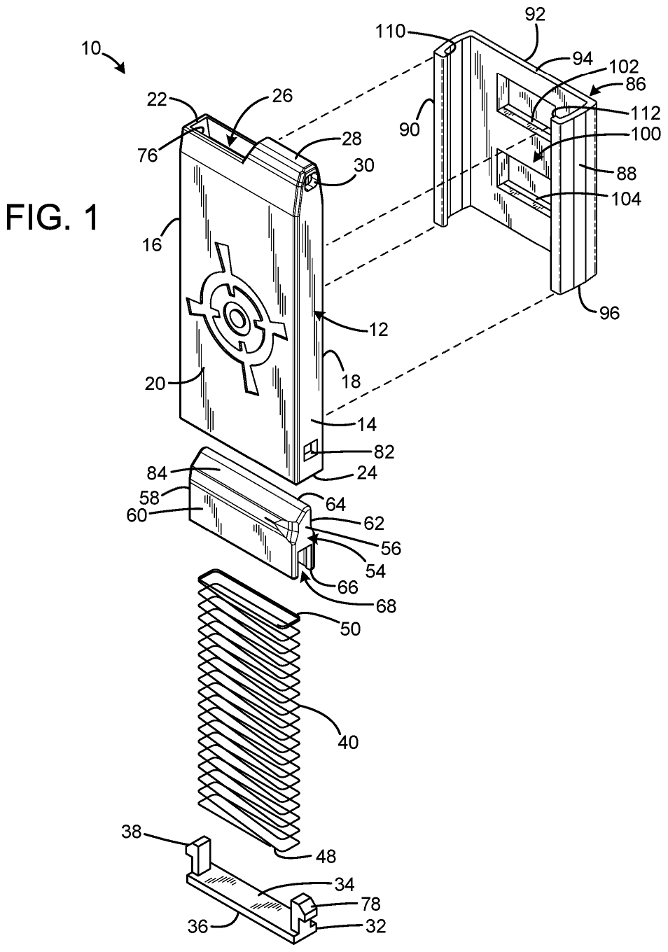

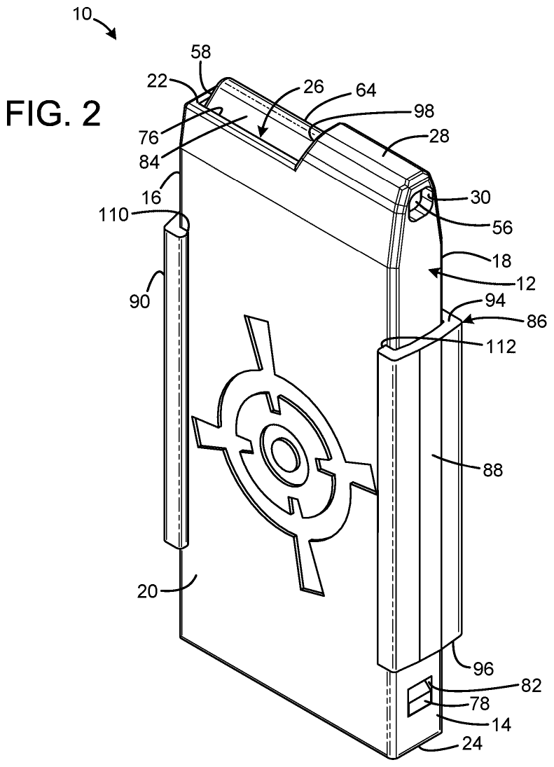

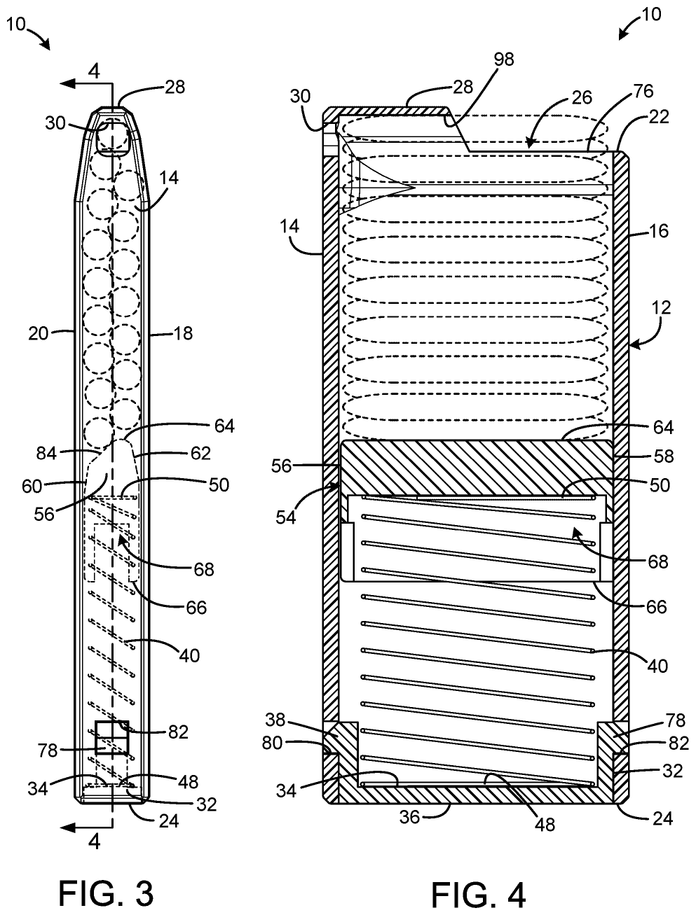

FIGS. 1-4 illustrate the improved magazine for light sticks 10 of the present invention. More particularly, the magazine body 12 is generally tubular with a central bore 26, and has a front 14, rear 16, left side 18, right side 20, upper end/top 22, and opposed lower end/bottom 24. The front and rear are opposed major side walls, and the front and rear walls are opposed and elongated. The body is hollow and rectangular, thereby defining an interior passage. The passage has a width adapted to receive a staggered double stack of light sticks. The central bore tapers inwards towards the top to feed a single elongated illumination stick/chemical light stick 52 at a time through the top aperture 76 in communication with the central bore. The top aperture is adapted to enable insertion of light sticks into the interior passage. The top front of the body includes a bridge 28 that defines a front aperture/ejection aperture 30, a rear aperture 98, extends from one major side wall to the other, extends less than half the length of the upper end, is proximate the front wall, and comprises bridge walls extending upward from the major sidewalls and toward each other to meet at a ridge. In the current embodiment, the front aperture is square, the rear aperture is a trapezoid, and both apertures are sized to give the ridge an interior width adapted to closely receive and permit the passage of a single two-inch long light stick 52 having a front 72, a rear 74, and a diameter of 0.236 inch in the current embodiment. The rear aperture is a first opening adjacent to the bridge/retention element, and the front aperture/ejection aperture is a second opening spaced apart by the first opening. The first opening has a width defined by the spacing between the major sidewalls, a length based on the distance between the front and rear walls less a length of the bridge/retention element, and extends to the rear wall. The second opening is defined in a panel parallel to the front wall and is proximate the front wall. The second opening has a width of 6.40 mm in the current embodiment. The body has a total height of 134.05 mm, which includes the bridge height of 8.50 mm, a width of 55.82 mm, and a thickness of 16.61 mm. The rear of the bridge is angled such that the top of the bridge is spaced 33.78 mm from the rear of the body, and the bottom of the bridge is spaced 29.48 mm from the rear of the body.

The bottom 24 of the body 12 is open to receive a follower 54 and a rectangular coil spring 40 within the central bore 26. A bottom lid 32 closes the bottom end of the body and secures the follower and spring within the central bore of the body. The bottom lid has a top 34 and a bottom 36. The top includes upwardly protruding latches 38, 78 that releasably secure the bottom lid to the bottom of the body. This is accomplished by the insertion of the latches into apertures 80, 82 in the front 14 and rear 16 of the body. The coil spring biases the follower towards an upper position adjacent to the upper end of the body and is compressed when the magazine body is loaded with light sticks 52. As a result, the follower reciprocates between the upper position and a lower position more proximate the lower end of the body. The bridge 28 serves as a retention element adapted to retain chemical light sticks within the interior passage against the biasing force of the spring.

The follower 54 has a front 56, rear 58, left side 60, right side 62, top 64, and bottom 66. The top of the follower has a smooth, angled platform portion 84 extending the length of the follower. The bottom of the follower defines a channel 68 that bifurcates the underside of the follower and receives the top end 50 of the coil spring 40.

An optional receiver 86 provides an alternative means for attaching the magazine for light sticks 10 to the user. The receiver has a front 88, rear 90, left 92, top 94, and bottom 96. The left side is open except for small protrusions 110, 112 extending from the front and rear of the receiver to define a channel 100 between the front, right, and rear. Upper and lower lots 102, 104 enable to user to mount the receiver parallel or perpendicular to the user's waistline when using changeable Modular Lightweight Load-carrying Equipment (MOLLE)-compatible securing straps. The front and rear of the receiver, including the small protrusions act as pressure fits around the rectangular body 12 to releasably secure the magazine for light sticks 10 within the channel 100.

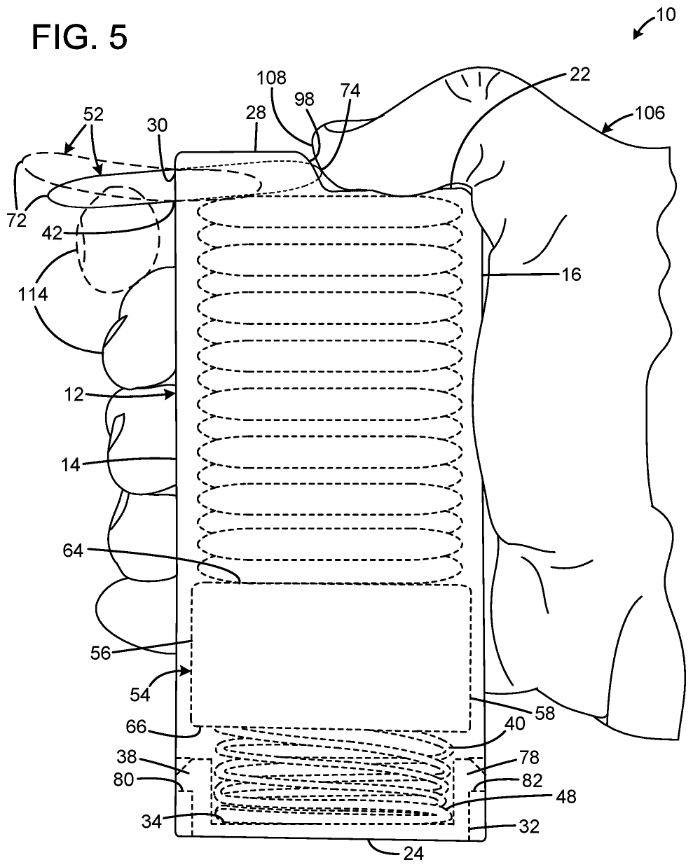

FIG. 5 depicts the procedure for dispensing and activating a light stick 52 from the magazine for light sticks 10. Usage of the magazine for light sticks 10 for storing and dispensing light sticks is particularly advantageous because the user can dispense and activate a light stick using only one hand 106. To dispense a light stick, the user first pushes the rear 74 of the uppermost light stick exposed by the top aperture 76 of the body 12 with a thumb 108 to force the front 72 of the light stick that is received under the bridge 28 through the rear aperture 98 and out the front aperture 30. To provide the thumb with leverage, the user grasps the front 14 of the body with a forefinger 114. An intermediate portion of the chemical light stick 42 is closely received by the front aperture/ejection aperture, such that a portion of the light stick protrudes from the body and a portion of the light stick is retained by the body to enable the light stick to be flexed for activation. Once a sufficient portion of the front of the light stick protrudes from the front aperture (about ½″ as denoted by the broken lines), the user grasps the rear 16 of the body with the thumb, places the forefinger below the front protruding portion of the light stick, and then flexes the light stick upwards until the light stick fractures internally to mix the chemicals stored within and activate the illumination-generating reaction. Finally, the user pinches the protruding front portion of the light stick between the thumb and forefinger and withdraws the rear of the light stick from under the bridge through the front aperture to dispense the activated light stick. The follower 54 then urges the stack of light sticks upwards until the newly uppermost light stick has its front retained by the bridge, ready to be dispensed by repeating the dispensing and activating procedure.

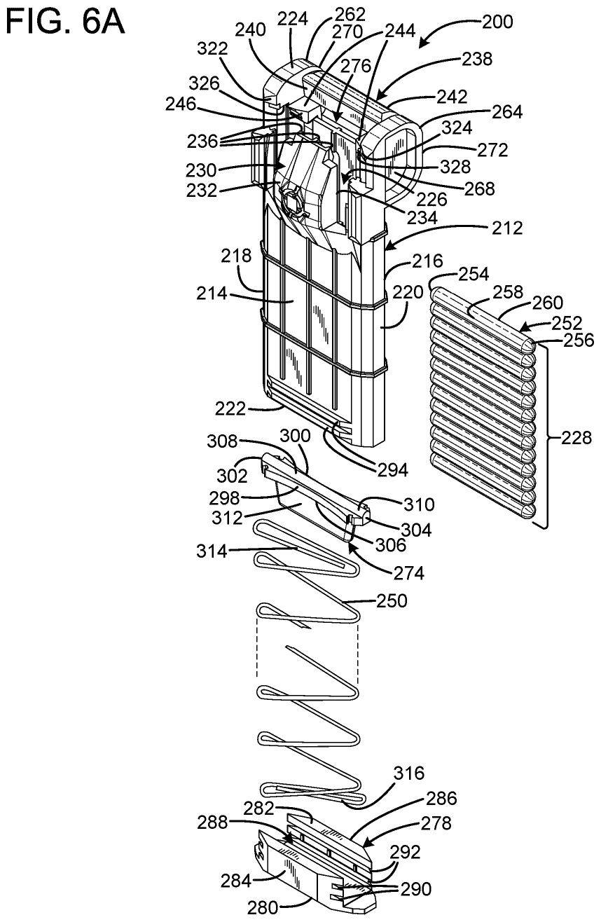

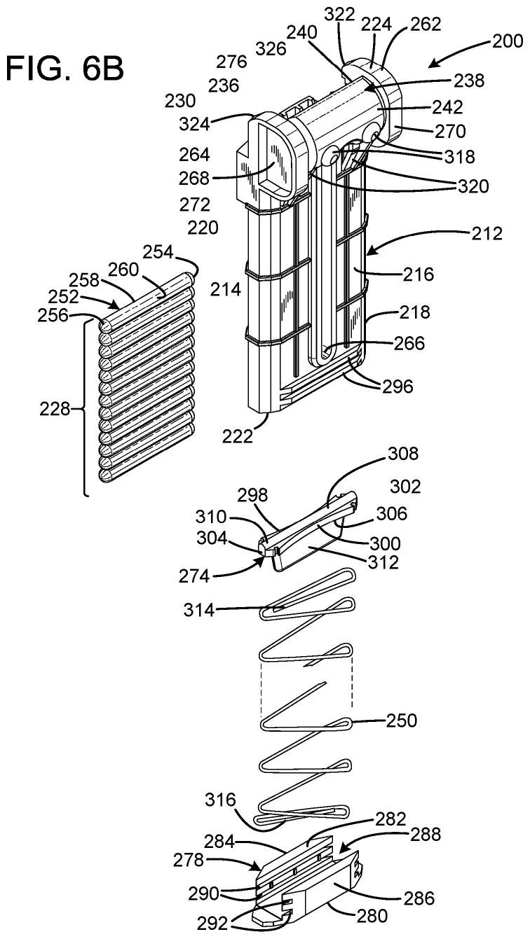

FIGS. 6A-B illustrate a first alternative embodiment of the improved magazine for light sticks 200 of the present invention. More particularly, the magazine body 212 is elongated and generally tubular with a central bore 226, and has a front 214, rear 216, left side 218, right side 220, upper end/top 222, and opposed lower end/bottom 224. The front and rear are opposed parallel major faces, and the front and rear walls are opposed and elongated. The body is hollow and rectangular, thereby defining an interior passage. The interior passage is a chamber having a width configured to contain a stack 228 of elongated light sticks 252. In the current embodiment, the stack of elongated light sticks is a single stack. The central bore feeds a single elongated illumination stick/chemical light stick at a time through the top aperture 276 in communication with the central bore. The top aperture is (exit aperture) communicates with the chamber and proximate to a light stick feeding position. The top aperture is adapted to enable insertion of light sticks into the interior passage. In the current embodiment, the top aperture permits the passage of a single two-inch long light stick having a left end 254, opposed right end 256, front surface 258, rear surface 260, and a diameter of 0.236 inch in the current embodiment. The bottom front of the body includes an anvil 230 having a front 232 and rear 234. The front of the anvil is a convex palm swell adapted to be cupped by the hand 106 of a user. The rear of the anvil includes three vertical ribs 236 (retention element) proximate the exit aperture that extend rearward in communication with the top aperture. The bottom rear of the body includes a movable actuator 238 having a front 240 and rear 242 that is proximate the exit aperture and movable between a rest position and an actuated position. The actuator is attached to the body by screws 318 that connect the actuator to spring arms 320 that extend downwards from the rear of the body. In the current embodiment, the spring arms bias the actuator rearwardly away from the rear of the anvil. The rear of the actuator is convex to facilitate gripping of the actuator by a user's fingers so the user can squeeze the actuator towards the anvil. Thus, the actuator is movable in a direction perpendicular to a length of the body and in a direction perpendicular to the opposed parallel major faces. The front of the actuator includes two arms 244, each having a front surface 246 (contact portion) spaced apart from the retention element. The bottom left and right sides of the body include a left ear 262 and a right ear 264. The left and right ears each define a thumb recess (the right ear's thumb recess 268 is visible. The left and right ears have convex rears 270, 272 to facilitate gripping of the ears by a user's fingers. The left and right ears have fronts 322, 324, each defining an upwardly facing feed lip 326, 328.

The top 222 of the body 212 is open to receive a follower 274 and a rectangular coil spring 250 within the central bore 226. A top lid 278 closes the top end of the body and secures the follower and spring within the central bore of the body. The top lid has a top 280 and a bottom 282. The bottom includes downwardly protruding front and rear sides 284, 286 that define a central channel 288. The front side defines a pair of slots 290, and the rear side defines a pair of slots 292. The pairs of slots communicate with the central channel. To releasably secure the top lid to the top of the body, the top of the body is slid sideways into the central channel such that ridges 294 defined on the top front of the body are slidably received within slots 290, and ridges 296 defined on the top rear of the body are slidably received within slots 292. The coil spring biases the follower towards a lower position adjacent to the bottom end of the body and is compressed when the magazine body is loaded with a stack 228 of light sticks 252. As a result, the follower reciprocates between the bottom position and an upper position more proximate the top end of the body. The upwardly facing feed lips 326, 328 on the left and right ears 262, 264 serve as retention elements adapted to retain the left and right ends 254, 256 of the lowermost light stick 252 of a stack 228 of light sticks within the interior passage against the downward biasing force of the spring. Thus, the feed lips are retaining elements configured to resist removal of the light stick occupying the light stick feeding position except in response to movement of the actuator to compress the spring. The retaining elements are a protrusion extending toward an opposite end of the chamber away from the exit aperture. The rear 216 of the body defines an elongated central slot 266 that communicates with the central bore.

The follower 274 has a front 298, rear 300, left side 302, right side 304, top 306, and bottom 308. The bottom of the follower has a convex rounded platform portion 310 extending the length of the follower. The top of the follower defines an upwardly protruding spring support 312 that is received by the bottom end 314 of the coil spring 250. The coil spring also has an opposed top end 316 that contacts the underside of the top 280 of the top lid 278 when the magazine for light sticks 200 is assembled. When the follower is received within the central bore 226 of the body 212, the follower is accessible by a finger inserted through the central slot 266. Thus, a user can engage the follower to overcome the coil spring and pull the follower to the top 222 of the body to load a stack 228 of light sticks 252 through the top aperture 276 into the central bore of the body. The elongated central slot can also be used to visually assess the quantity of light sticks remaining in the body. The body defines a vertical feed axis 330, and the spring coil spring is adapted to urge the stack of light sticks toward the exit aperture.

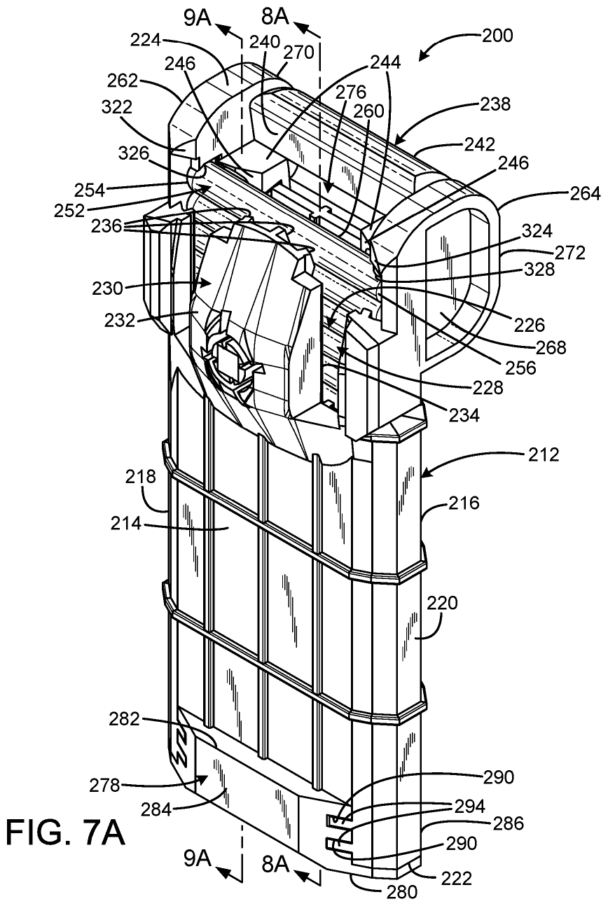

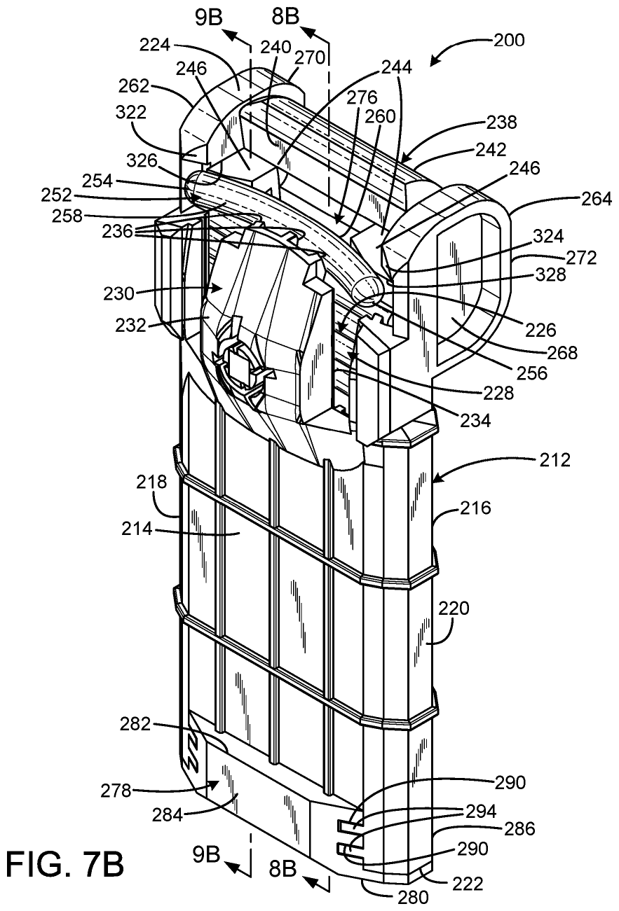

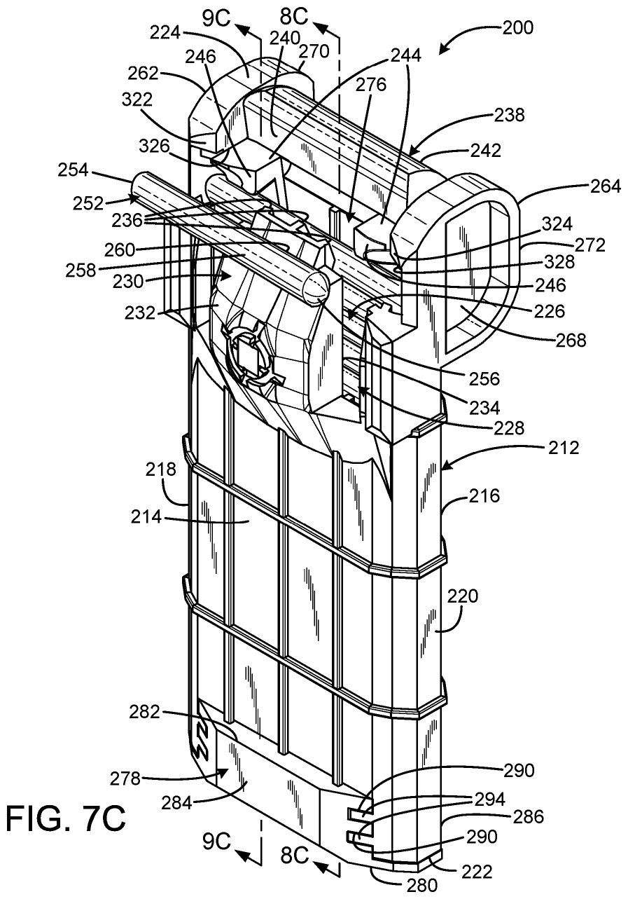

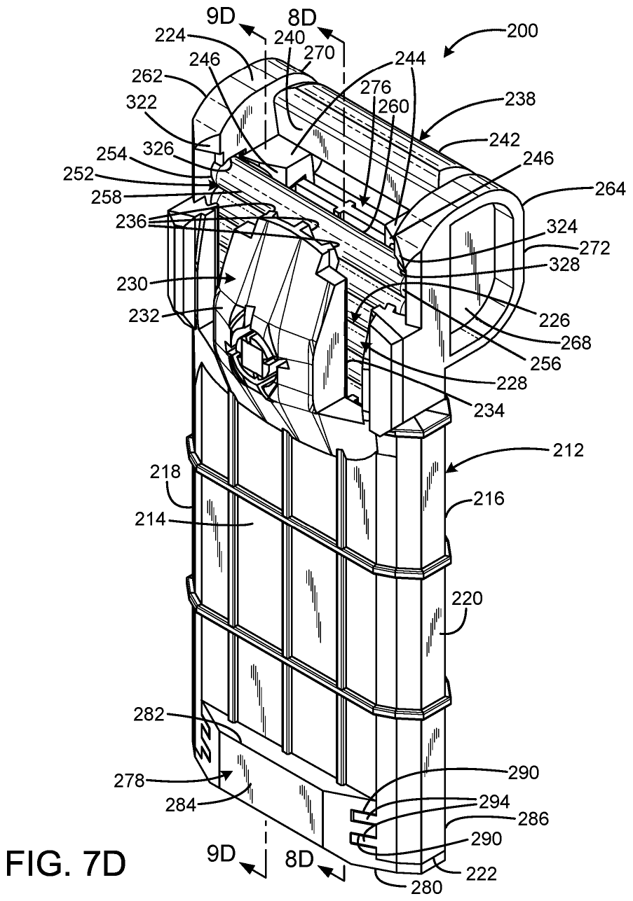

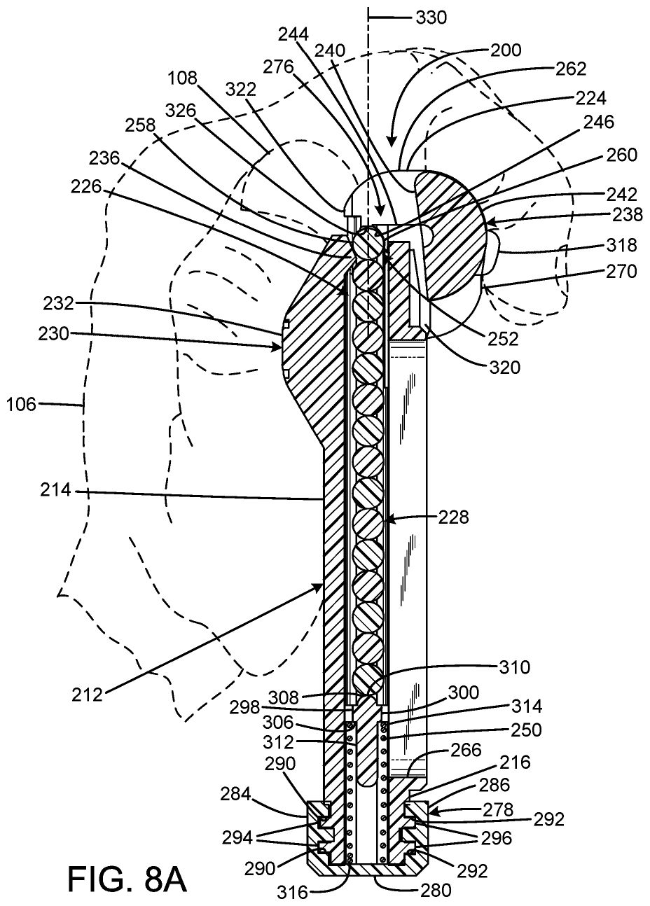

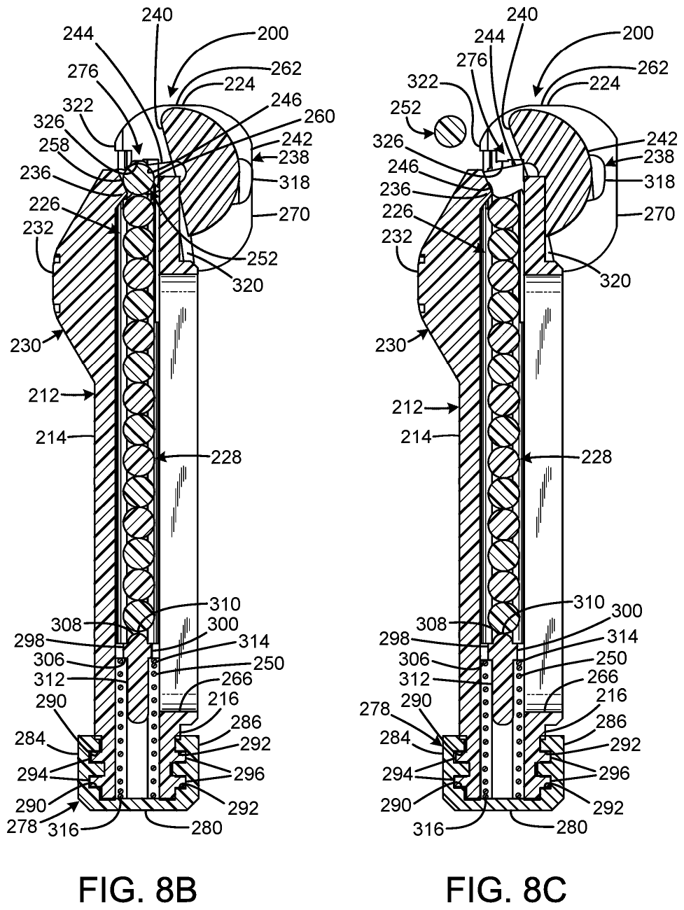

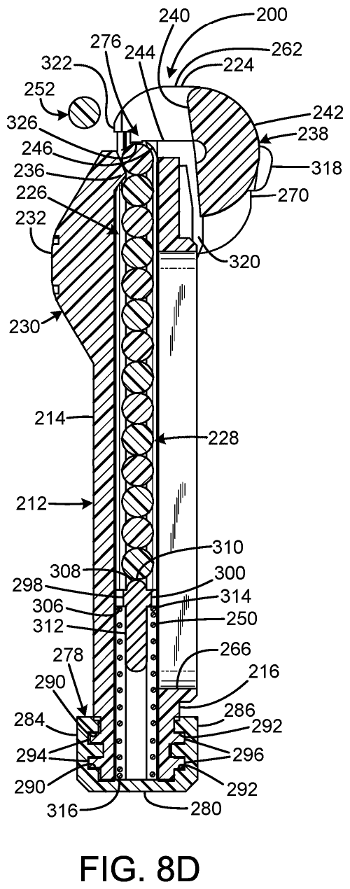

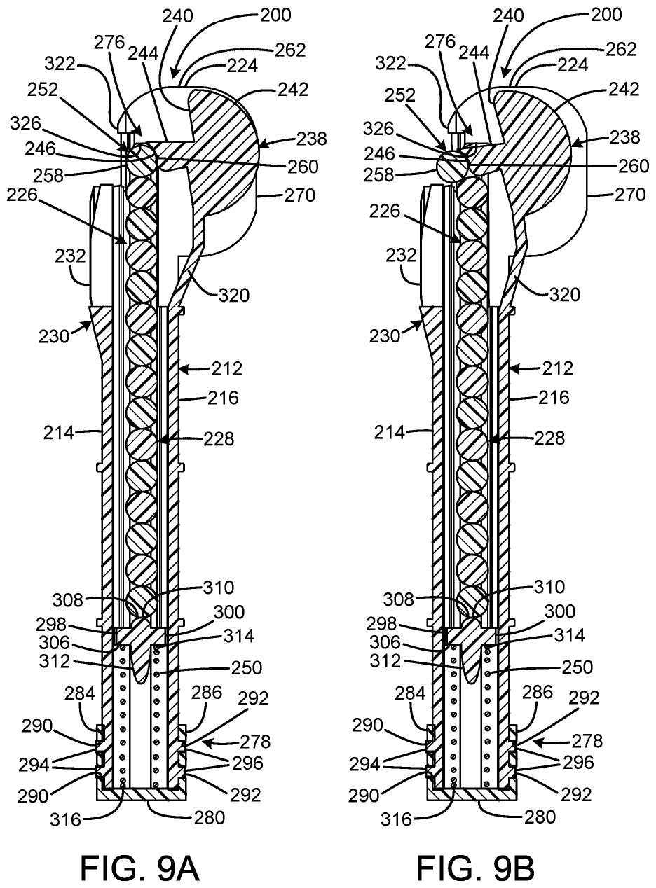

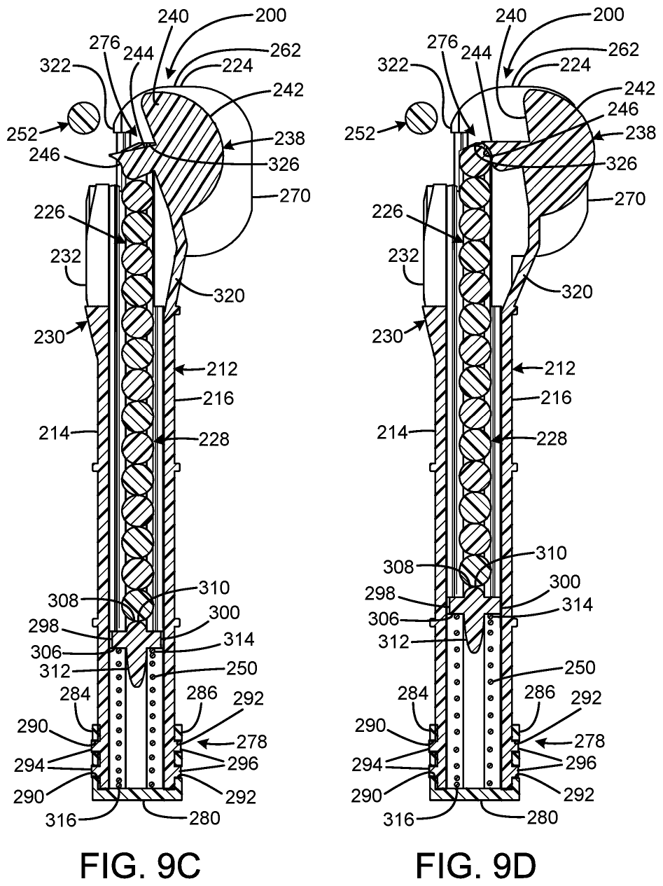

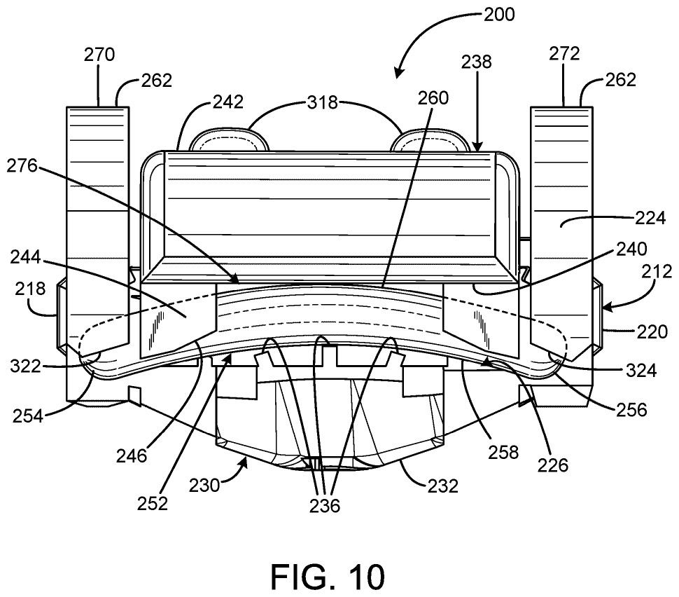

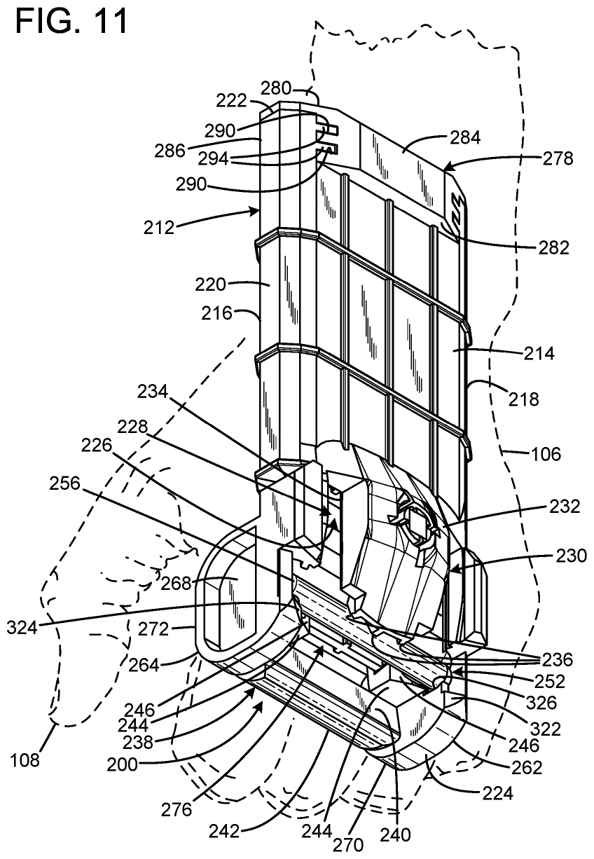

FIGS. 7A-11 depict the procedure for dispensing and activating a light stick 252 from the magazine for light sticks 200. Usage of the magazine for light sticks 200 for storing and dispensing light sticks is particularly advantageous because the user can dispense and activate a light stick using only one hand 106. To dispense a light stick from the ready to dispense position of the magazine for light sticks 200 shown in FIGS. 7A, 8A & 9A, the user first grips the bottom 224 of the magazine body 212 by cupping the front 232 of the anvil 230 with his or her hand 106, engaging his or her thumb 108 in either thumb recess depending on whether the user's right or left handed, and gripping the rear 242 of the actuator 238 with his or her fingers (shown in FIG. 11). The user than squeezes the actuator forward towards the rear 234 of the anvil. As the actuator moves forward, the front surfaces 246 of the arms 244 contact the rears 260 of the left and right ends 254, 256 of the lowermost light stick 252 and push the light stick towards the rear of the anvil. As the actuator moves forward, the front 258 of the light stick contacts the ribs 236 of the anvil, which causes the left and right ends of the light stick to flex forward (shown in FIGS. 7B, 8B, 9B & 10). Thus, the retention element and contact portion are operable to flex a light stick occupying the light stick feeding position in response to movement of the actuator from the rest position to the actuated position. Pressure exerted by the ribs on the front of the light stick eventually causes a glass vial (not shown) contained within the light stick to fracture in multiple locations. Thus, one of the retention element and the contact portion is configured to contact the light stick occupying the light stick feeding position at an end portion of the light stick, and the other of the retention element and contact portion is configured to contact the light stick occupying the light stick feeding position at an intermediate portion of the light stick. Furthermore, one of the retention element and the contact portion is configured to contact the light stick occupying the light stick feeding position at opposed end portions of the light stick, and the other of the retention element and contact portion is configured to contact the light stick occupying the light stick feeding position at an intermediate portion of the light stick. In addition, the contact portion includes a plurality of contact points along the length of the light sticks and is operable to flex the light stick at each of the contact points. The fracturing of the glass vial enables a first chemical (not shown) contained within the glass vial to mix with a second chemical (not shown) contained within the light stick outside of the glass vial. The first and second chemicals chemically react to form a third chemical (not shown). The chemical reaction produces visible light. The fracturing of the glass vial in multiple locations enables the first and second chemicals to mix more rapidly than they could if the glass vial were fractured in only one location. As a result, a vigorous chemical reaction is quickly induced, and the light stick rapidly produces visible light without a delay that could occur if the glass vial were fractured in only one location.

As the left and right ends 254, 256 of the lowermost light stick 252 flex forward, the left and right ends of the lowermost light stick escape out from under the upwardly facing feed lips 326, 328. Once the user releases the actuator 238, the spring arms 320 urge the actuator rearwards to return the magazine for light sticks 200 to the ready to dispense position. Once the actuator's arms are no longer squeezing the light stick against the ribs 236 of the anvil 230, the light stick is free to fall downward through the top aperture 276 into the user's hand 106 (shown in FIGS. 7C, 8C & 9C). Thus, retention element and contact portion are operable to eject the light stick occupying the light stick feeding position in response to movement of the actuator from the rest position to the actuated position. Furthermore, the actuator is configured to initially flex a light stick in a flexed condition and to retain the light stick while the actuator is in the actuated position, and to release the light stick from the magazine when subsequently returned to the rest position. Simultaneously, the follower 274 is urged downward by the coil spring 250 to lower the stack 228 of light sticks so a new lowermost light stick is ready to be dispensed. At this point, the magazine for light sticks 200 is returned to the ready to dispense position shown in FIGS. 7D, 8D & 9D).

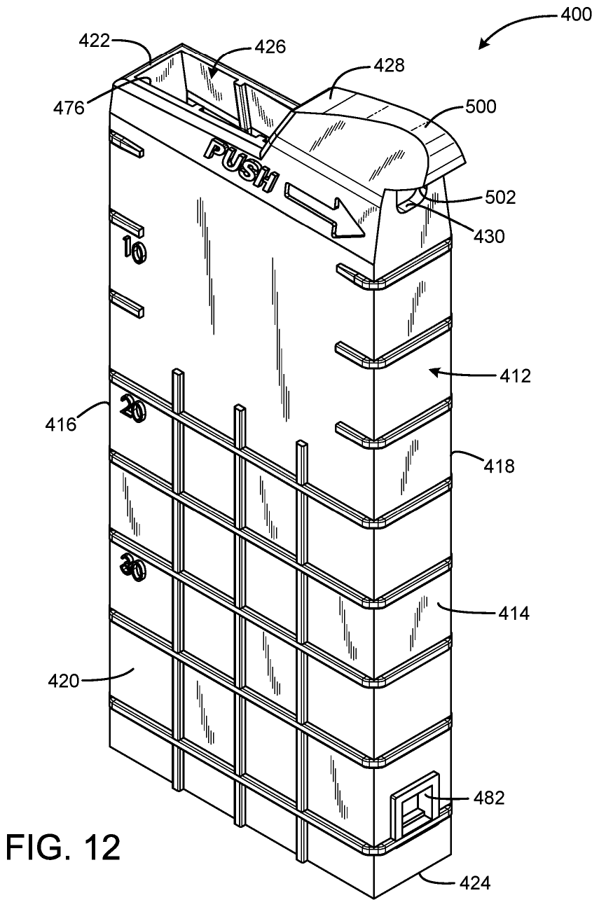

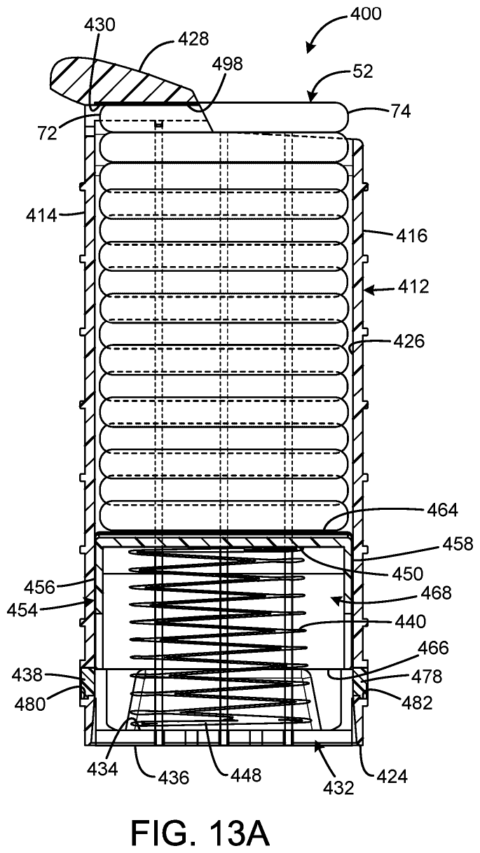

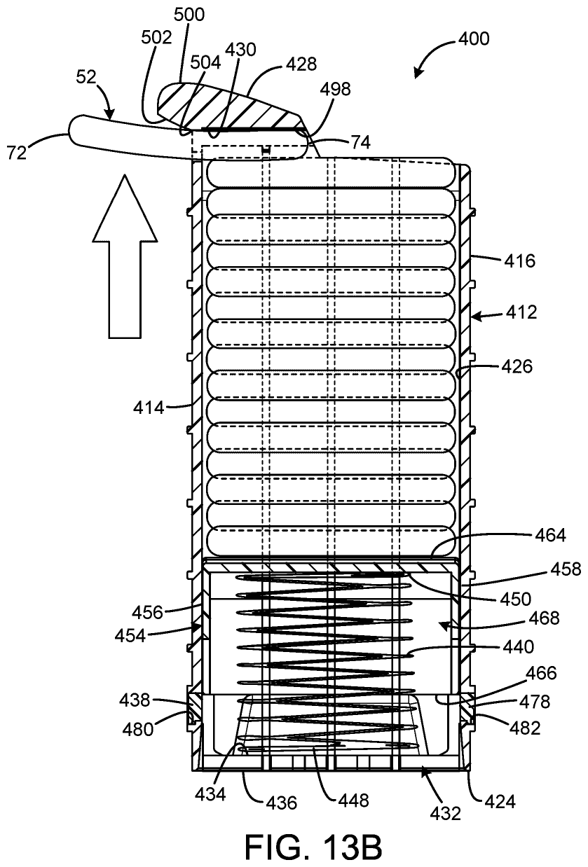

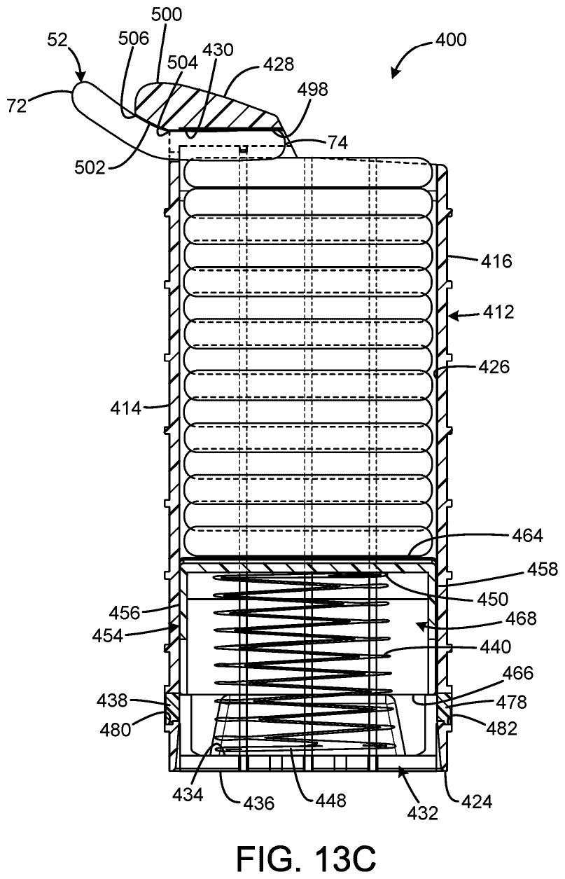

FIGS. 12-13A illustrate a second alternative embodiment of the improved magazine for light sticks 400 of the present invention. More particularly, the magazine body 412 is generally tubular with a central bore 426, and has a front 414, rear 416, left side 418, right side 420, upper end/top 422, and opposed lower end/bottom 424. The front and rear are opposed major side walls, and the front and rear walls are opposed and elongated. The body is hollow and rectangular, thereby defining an interior passage. The passage has a width adapted to receive a staggered double stack of light sticks. The central bore tapers inwards towards the top to feed a single elongated illumination stick/chemical light stick 52 at a time through the top aperture 476 in communication with the central bore. The top aperture is adapted to enable insertion of light sticks into the interior passage. The top front of the body includes a bridge 428 that defines a front aperture/ejection aperture 430, a rear aperture 498, extends from one major side wall to the other, extends less than half the length of the upper end, is proximate the front wall, and comprises bridge walls extending upward from the major sidewalls and toward each other to meet at a ridge. In the current embodiment, the front aperture is square, the rear aperture is a trapezoid, and both apertures are sized to give the ridge an interior width adapted to closely receive and permit the passage of a single two-inch long light stick 52 having a front 72, a rear 74, and a diameter of 0.236 inch in the current embodiment. The bridge includes a front extension 500 that extends above the front aperture and protrudes forward beyond the front wall. The underside 502 of the front extension is a surface that is arcuate and convex in shape having a radius of 28.19 in the current embodiment. The rear aperture is a first opening adjacent to the bridge/retention element, and the front aperture/ejection aperture is a second opening spaced apart by the first opening. The first opening has a width defined by the spacing between the major sidewalls, a length based on the distance between the front and rear walls less a length of the bridge/retention element, and extends to the rear wall. The second opening is defined in a panel parallel to the front wall and is proximate the front wall. The second opening has a width of 6.40 mm in the current embodiment.

The bottom 424 of the body 412 is open to receive a follower 454 and a rectangular coil spring 440 within the central bore 426. A bottom lid 432 closes the bottom end of the body and secures the follower and spring within the central bore of the body. The bottom lid has a top 434 and a bottom 436. The top includes upwardly protruding latches 438, 478 that releasably secure the bottom lid to the bottom of the body. This is accomplished by the insertion of the latches into apertures 480, 482 in the front 414 and rear 416 of the body. The coil spring biases the follower towards an upper position adjacent to the upper end of the body and is compressed when the magazine body is loaded with light sticks 52. As a result, the follower reciprocates between the upper position and a lower position more proximate the lower end of the body. The bridge 428 serves as a retention element adapted to retain chemical light sticks within the interior passage against the biasing force of the spring.

The follower 454 has a front 456, rear 458, left side (not visible), right side (not visible), top 464, and bottom 466. The top of the follower has a smooth, angled platform portion (not visible) extending the length of the follower. The bottom of the follower defines a channel 468 that bifurcates the underside of the follower and receives the top end 450 of the coil spring 440.

FIGS. 13B-C depict the procedure for dispensing and activating a light stick 52 from the magazine for light sticks 400. Usage of the magazine for light sticks 400 for storing and dispensing light sticks is particularly advantageous because the user can dispense and activate a light stick using only one hand 106. To dispense a light stick, the user first pushes the rear 74 of the uppermost light stick exposed by the top aperture 476 of the body 412 with a thumb 108 to force the front 72 of the light stick that is received under the bridge 428 through the rear aperture 498 and out the front aperture 430. To provide the thumb with leverage, the user grasps the front 414 of the body with a forefinger 114. An intermediate portion of the chemical light stick 42 is closely received by the front aperture/ejection aperture, such that a portion of the light stick protrudes from the body and a portion of the light stick is retained by the body to enable the light stick to be flexed for activation. Once a sufficient portion of the front of the light stick protrudes from the front aperture (about ½″), the user grasps the rear 416 of the body with the thumb, places the forefinger below the front protruding portion of the light stick, and then flexes the light stick upwards until the light stick fractures internally to mix the chemicals stored within and activate the illumination-generating reaction. As is shown in FIG. 13B, the light stick first fractures internally as the intermediate portion of the light stick encounters location 504 of the front extension 500. As the user continues to flex the light stick upwards, the light stick encounters additional portions of the underside 502 of the front extension, including location 506, and fractures internally at one or more additional locations. In the current embodiment, the horizontal distance between the fracture points at 504 and 506 is 7.03 mm, and the vertical distance between the fracture points at 504 and 506 is 3.34 mm. The fracturing of the glass vial (not shown) in multiple locations within the light stick enables the first and second chemicals to mix more rapidly than they could if the glass vial were fractured in only one location. As a result, a vigorous chemical reaction is quickly induced, and the light stick rapidly produces visible light without a delay that could occur if the glass vial were fractured in only one location. Finally, the user pinches the protruding front portion of the light stick between the thumb and forefinger and withdraws the rear of the light stick from under the bridge and under the front extension through the front aperture to dispense the activated light stick. The follower 454 then urges the stack of light sticks upwards until the newly uppermost light stick has its front retained by the bridge, ready to be dispensed by repeating the dispensing and activating procedure.

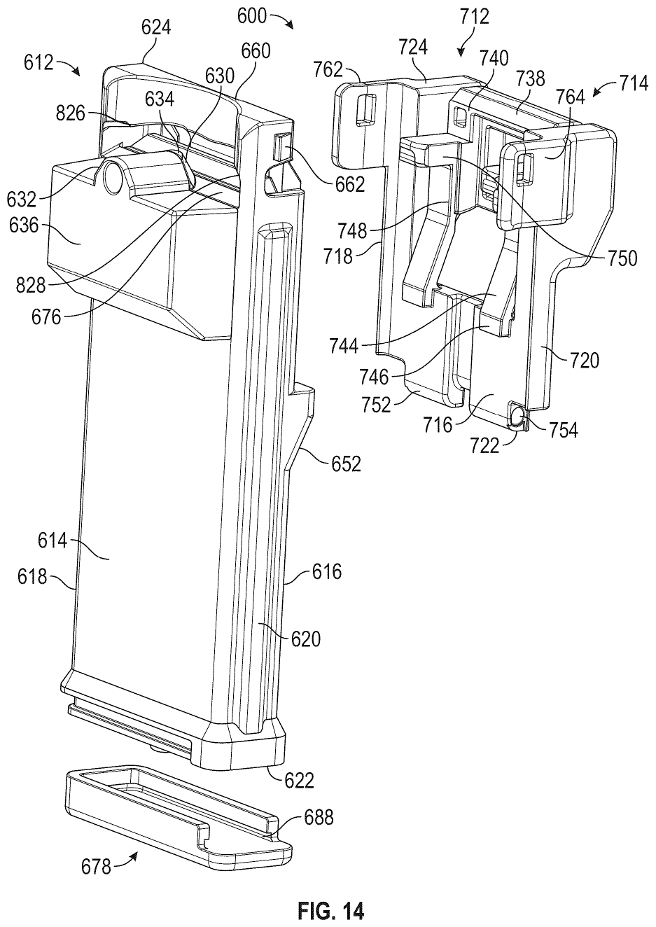

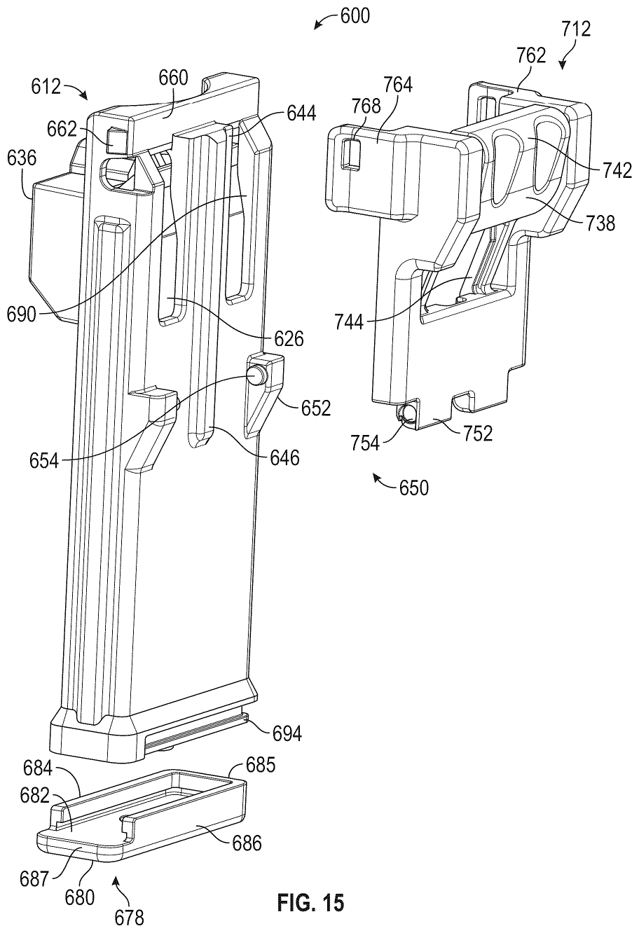

FIGS. 14-16 illustrate an alternative embodiment of the improved magazine for light sticks 600 of the present invention of FIG. 6-11. The magazine body 602 includes a first body 612 and a second body 712. More particularly, the first body 612 is elongated and generally tubular with a central bore 626 (shown best in FIG. 15), and has a front 614, rear 616, left side 618, right side 620, upper end/top 622, and opposed lower end/bottom 624. The front and rear 614, 616 are opposed parallel major faces, and the front and rear walls are opposed and elongated. The second body 712 has a front 714, rear 716, left side 718, right side 720, upper end/top 722, and opposed lower end/bottom 724. In some instances, the rear sides of the first and second bodies may be referred to as a first side. In some instances, the left and right sides of the first and second bodies may be referred to as a second and third side. The upper end/top 722 may also be referred to as a first end. The bottom/lower end 724 may also be referred to as a second end. In the example magazine body 602, the second body 712 is attached to the first body 612 at a hinge arrangement 650 as will be described in greater detail later.

The first body 612 is hollow and rectangular, thereby defining an interior passage. The interior passage is a chamber having a width configured to contain a stack of elongated light sticks. It is understood the stack of elongated light sticks in the same as previous embodiments and are not redescribed. The central bore 626 feeds a single elongated illumination stick/chemical light stick at a time through the top aperture 676 in communication with the central bore. The top aperture (exit aperture) communicates with the chamber and proximate to a light stick feeding position. The top aperture is adapted to enable insertion of light sticks into the interior passage. The bottom front of the first body 612 includes an anvil 630 having a front 632 and rear 634. The anvil 630 serves as fulcrum for the flexing of the light sticks to fracture an internal element (not shown). The front of the anvil 630 is a convex palm swell 636 adapted to be cupped by the hand 106 of a user. The convex palm swell 636 can be different sizes and shapes for ease of use and comfort of the user. As non-limiting examples, the convex palm swell 636 may be square, rounded, a ball, or any shape comfortable for a user's palm or hand. Further, the size of the convex palm swell may be larger to fit a larger palm or small to fit a smaller palm as desired.

Referring to FIGS. 14 and 15, the second body 712 is joined to the first body 612 to allow a movable actuator 738 to assist in cracking and ejecting of the elongated light sticks. The movable actuator 738 having a front 740 (shown in FIG. 14) and rear 742 (shown in FIG. 15) that is proximate the exit aperture and movable between a rest position and an actuated position. The movable actuator 738 is integrally formed as a single unitary piece of the second body 712 and include a pair of spring arms 744 (shown in FIG. 14) and two engagement arms 750 (shown in FIG. 14). The pair of spring arms 744 are positioned on the rear side 616 and are integrally formed with the second body 712. The spring arms 744 include a first end 746 attached to front 740 of the second body 712 and a second end 748 attached to a front side 740 of the actuator 738. The two-spring arms 744 are flexible such that when a force is applied to the actuator 738, the two spring arms 744 flex inward and the two engagement arms 750 to press against the light sticks. Further, the spring arms 744 allows movement of the movable actuator 738 separate from the rest of the second body 712. The spring arms 744 may also be considered a living hinge within the second body 712.

The first body 612 may further include two slots 640 (shown in FIG. 15) formed at rear side 616 allowing the actuator 738 to press against the light stick when actuated. The two slots 640 are separated by an intermediate region 644 (shown in FIG. 15). Each engagement arm 750 is inserted around the intermediate region 644 and into one of respective slots 640. In some instances, the intermediate region 644 may be flush with the slots on the rear side 616. In the example magazine body, the intermediate region 644 includes a raised portion 646 which extends outward from rear farther than the slots 640. When actuated, the engagement arms 750 extend further through the slots 640 and into the internal passage to bend the light sticks against the anvil 630. As will be described in greater detail later, the anvil 630 acts as a fulcrum for cracking the light sticks and assists in ejecting the light stick out from the light stick feeding position automatically. In the example magazine body 602, the second body 712 may also include recessed area which receive the intermediate region 644 on the front side 740 of the second body 712 when in a non-rotatable configuration. In some examples, the pair of spaced apart engagement arms 738 and the anvil 630 may be placed on the other of the first and second body respectively. For instance, the first body 612 may instead include the pair of spaced apart engagement arms 738 and the second body 712 may include the anvil 630.

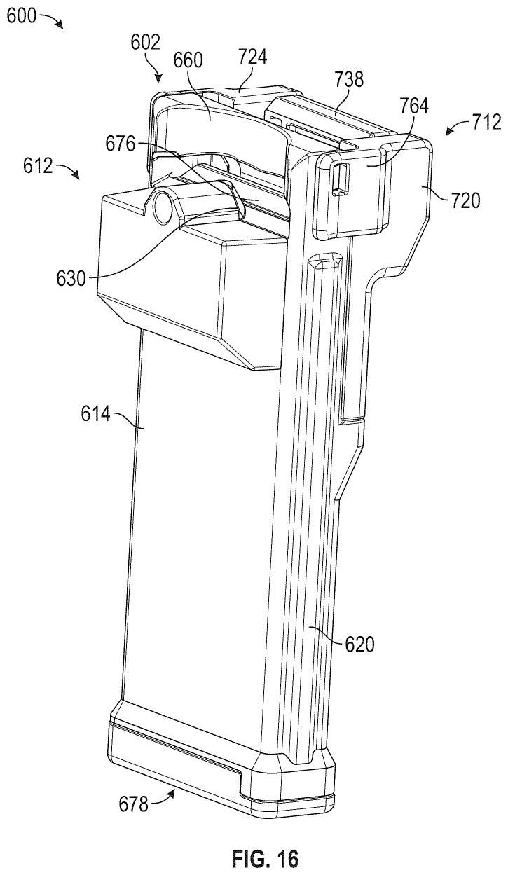

Referring to FIG. 16-18, the hinge arrangement 650 (shown in FIG. 15) is configured to allow the pivoting of the second body 712 around the first body 612. The hinge arrangement 650 is defined by a portion of the first body 612 joined with a portion of the second body 712. For instance, the hinge arrangement 650 can be defined by two angled surfaces 652 of the first body 612 configured to receive hinge arms 752 of the second body 712. The first body 612 includes two angled surfaces 652 projecting from the rear side 616 of the first body 612. Each of one the two angled surfaces 652 include two prongs 654, which project inwardly toward each other. The prongs 654 may connect with hinge arms 752 of the second body 712 to form a hinge arrangement 650.

The second body 712 include hinge arms 752 that extend downwards from the top of the second body 712. The hinge arms 752 include two recesses 754 (shown in FIG. 15) which receive the two prongs 654 of the first body to form the hinge arrangement 650. The hinge arms may be resiliently flexed to engage the prongs in a snap-fit connection. The two hinge arms 752 are separated by a space which allows the second body 712 to rotate away from the first body 612 without abutting against the raised portion 646 (shown in FIG. 15) of the intermediate region 644. When rotated away from the first body 612, the intermediate region 644 may be positioned between the two hinge arms 752. In other examples, the hinge arms 752 may include the prongs and the first body 612 may include the recesses 754.

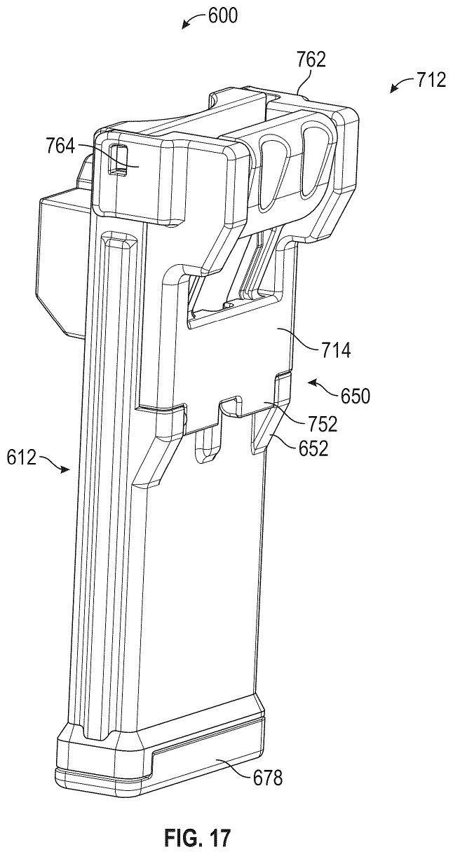

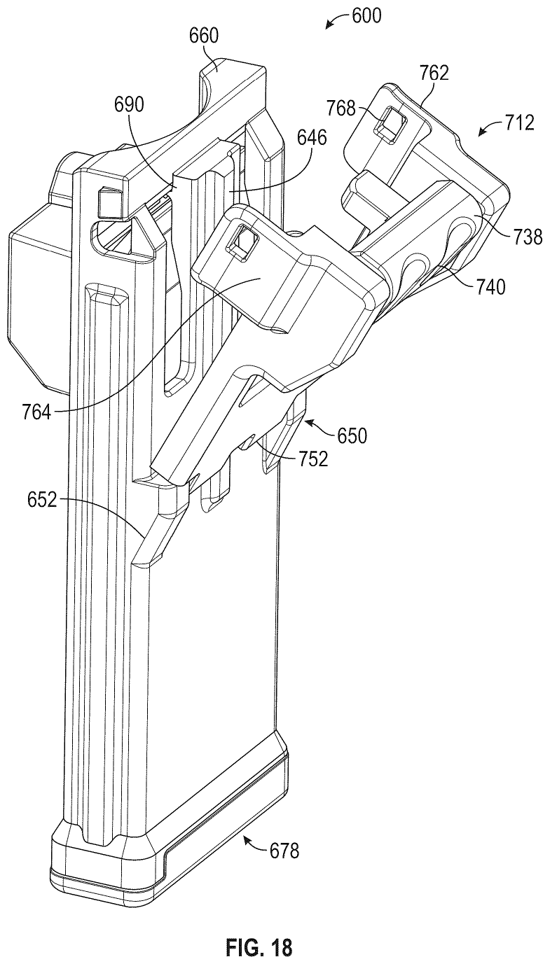

Referring to FIGS. 16 and 17, the second body 712 is pivotable around the first body 612. As such, the second body 712 is movable between a non-rotatable configuration (shown in FIG. 16) and a rotatable configuration (shown in FIG. 18). The first body 612 may include a U-shaped body 660 (shown in FIG. 16) at the bottom of the first body 612. The U-shaped body 660 includes upwardly facing feed lips 826 and 828 on the left and right sides of the U-shaped body. The U-shaped body is configured to connect with left and right ears 762, 764 of the second body 712. The left and right ears may also be referred to as a first and second clasps. The intermediate region 642 is connected to a center of the U-shaped body 660 (see FIG. 15). The U-shaped body 660 may include two projections 662 which may be received within an opening 768 (shown in FIG. 18) on each of the left and right ear 762, 764. The two projections 662 retain the ears 762, 764 of the second body 712 to first body 612 via the openings 768. The ears 762, 764 of the second body are configured to be pulled apart to release the projections 662 from the openings 768 and place the second body in the rotating configuration. The openings 768 along with the hinge 650 together holding the second body 712 in the non-rotatable configuration (shown in FIG. 16). Further, the actuator 738 remains flexibly movable while the second body 712 is joined at the hinge arrangement 650 and U-shaped body 660 in the non-rotatable configuration.

The projections 662 angle downwardly along a length of the projection 662 extending toward the rear side of the first body 612. The projections 662 may angle downwardly until flush with the sides of the first body 612. As such, the two projections 662 may be released from the openings 768 to a rotatable configuration (shown in FIG. 17), and the second body 712 may be rotated away from the first body 612. In the rotatable configuration, the magazine may be easier loaded by moving the engagement arms away from the internal passage.

Referring back to FIG. 14, the top 622 of the body 612 is open to receive a follower and a rectangular coil spring within the central bore 626. It should be understood the follower and coil spring may be a similar follower and coil spring described in other embodiments and is not redescribed here. A top lid 678 closes the top end of the first body 630 and secures the follower and spring within the central bore 626 of the body. The top lid 678 has a top 680 and a bottom 682. The bottom includes downwardly protruding front, left, and rear, sides 684, 685, 686 that define a central channel 688. The interior of the top lid 678 defines a slot 690 around the interior of top 678 at the front, right, and rear sides 684, 685, 686. The slot 690 communicates with the central channel 688. To releasably secure the top lid 678 to the top of the first body 612, the top of the first body is slid sideways into the central channel such that ridges 694 of the first body 612 slidably received within slots 690 defined around the interior of the front, left, and rear 684, 685, 686. The left side of the top lid 678 acts as a stop to connect the lid the first body 612.

The coil spring biases the follower towards a lower position adjacent to the bottom end of the body and is compressed when the magazine body is loaded with a stack of light sticks. As a result, the follower reciprocates between the bottom position and an upper position more proximate the top end of the body. The upwardly facing feed lips 826, 828 of the U-shaped body 660 serve as retention elements adapted to retain the left and right ends of the lowermost light stick of a stack of light sticks within the interior passage against the downward biasing force of the spring. Thus, the feed lips 826, 828 are retaining elements configured to resist removal of the light stick occupying the light stick feeding position except in response to movement of the actuator to compress the spring. For instance, the pressure of the actuator 738 moves the left and right ends light stick away from the upward feeding lips 826, 828, while the anvil 630 acts as a fulcrum for the light sticks to bend around. The light stick is ejected from the light stick feeding position by a single movement of the movable actuator 738 to the actuated position. As such, a single actuation fractures an internal element of the light stick and ejects the light stick from the magazine 600.

Advantageously, the actuator 738 being attached at a hinge 650 to the first body 612 430 allows the actuator 738 to also be rotated away from the first body 612. As such, the actuator 738 is clear of the internal passage of the central bore 626. The clearance allows easier loading of the elongated light sticks into the central bore from the bottom through the top aperture 676. Further, the magazine body 602 being separated into the two pieces improves manufacturing of the magazine 600. The first and second bodies may easily be molded individually and assembled together to form the magazine with improved reloadability.

While current embodiments of a magazine for light sticks have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A light stick-dispensing magazine comprising:
a first body defining a chamber configured to contain a plurality of light sticks, the first body defining an exit aperture communicating with the chamber and proximate to a light stick feeding position,
a second body pivotable about the first body, the second body including a movable actuator movable between a rest position and an actuated position;
an anvil configured for at least one of the plurality of light sticks to bend around;
a pair of spaced apart engagement arms; and
wherein the pair of spaced apart engagement arms are operable to flex the at least one of the plurality of light sticks occupying the light stick feeding position against the anvil to fracture an internal element, and wherein the internal element of the light stick is actuated by being fractured in response to movement of the movable actuator from the rest position to the actuated position.

2. The light stick-dispensing magazine of claim 1, wherein the second body includes the pair of spaced apart engagement arms, and the first body includes the anvil.

3. The light stick-dispensing magazine of claim 1, wherein the first body includes the pair of spaced apart engagement arms, and the second body includes the anvil.

4. The light stick-dispensing magazine of claim 1, further comprising a hinge arrangement configured to pivot of the second body around the first body.

5. The light stick-dispensing magazine of claim 4, wherein the hinge arrangement further comprises the first body including a pair of prongs, and the second body including a pair of hinge arms extending from the second body and wherein each of the hinge arms include a recess configured to receive one prong of the pair of prongs.

6. The light stick-dispensing magazine of claim 1, wherein the second body is movable between a non-rotatable configuration and a rotatable configuration.

7. The light stick-dispensing magazine of claim 6, wherein the second body includes two clasps, each clasp positioned on opposite sides of the second body, wherein each clasp includes an opening; wherein the first body includes two projections on opposite sides of the first body, and wherein the openings are configured to receive one of the two projections and hold a second end of the second body in the non-rotatable configuration.

8. The light stick-dispensing magazine of claim 7, wherein the two clasps of the second body are configured to be pulled away from the first body to release the two projections from the openings and place the second body in the rotatable configuration.

9. The light stick-dispensing magazine of claim 1, wherein a first side of the anvil facing away from the chamber includes a convex palm swell.

10. The light stick-dispensing magazine of claim 1, wherein the movable actuator further comprising a pair of spring arms, and wherein the pair of spring arms are positioned on a first side of the second body, the first side of the second body facing the first side of the first body, and wherein the pair of spring arms are integrally formed with the second body.

11. An apparatus comprising:
a first body defining a chamber configured to contain a plurality of elongated light sticks, the first body defining an exit aperture communicating with the chamber and proximate to a light stick feeding position;
a second body pivotable about the first body, the second body including an actuator movable between a rest position and an actuated position;
an anvil configured for a light stick within the light stick feeding position to bend around;
a pair of engagement arms; and
wherein the pair of engagement arms are operable to flex the light stick occupying the light stick feeding position against the anvil of the first body to fracture an internal element, and wherein the light stick is ejected from the light stick feeding position by a single movement of the actuator to the actuated position.

12. The apparatus of claim 11, wherein the second body includes the pair of engagement arms, and the first body includes the anvil.

13. The apparatus of claim 11, wherein the first body includes the pair of engagement arms, and the second body includes the anvil.

14. The apparatus of claim 11, wherein the second body is movable between a non-rotatable configuration and a rotatable configuration.

15. The apparatus of claim 11, further comprising a hinge arrangement configured to pivot of the second body around the first body.

16. The apparatus of claim 15, wherein the hinge arrangement further comprises the first body including a pair of prongs, and the second body including a pair of hinge arms extending from the second body and wherein each of the hinge arms include a recess configured to receive the prongs.

17. The apparatus of claim 11, wherein the second body comprises a first clasp and a second clasp configured to clasp to the first body and hold the second body in a non-rotatable configuration, wherein the first body includes first projection and a second projection, each projection received within one of the first and second clasp.

18. The apparatus of claim 17, wherein the first and second claps are configured to unclasp to place the second body to a rotatable configuration, and wherein the pair of engagement arms are configured to move away from a central bore of the first body when the second body is pivoted away from the first body in the rotatable configuration.

19. An apparatus for dispensing light-sticks comprising:
a first body defining a chamber configured to contain a stack of elongated light sticks, the first body defining an exit aperture communicating with the chamber and proximate to a light stick feeding position, the first body including an anvil for a light stick within the light stick feeding position to bend around;
a second body pivotable about the first body, the second body comprising a movable actuator movable between a rest position and an actuated position; and
wherein the movable actuator comprises a pair of engagement arms, wherein the pair of engagement arms are operable to flex a light stick occupying the light stick feeding position against the anvil to fracture an internal element, and wherein the internal element of the light stick is actuated by being fractured in response to movement of the movable actuator from the rest position to the actuated position.

20. The apparatus of claim 19, further comprising a hinge arrangement configured to join the first body and the second body in a snap-fit connection.
